(19) United States
(12) Patent Application Publication
(10) Pub. No.: US 2026/0311683 A1
(43) Pub. Date: Oct. 8, 2026

(54) ADAPTIVE CONTEXT-BASED AUTOMATED TELLER MACHINE (ATM) SCREEN VOCALIZATION AND PRINTING

(71) Applicant: Bank of America Corporation, Charlotte, NC (US)

(72) Inventors: Maneesh Kumar Sethia, Hyderabad (IN); Abhijit Behera, Hyderabad (IN); Madala Rajasekhar, Hyderabad (IN); Tejaswi Gundapu, Guntur (IN); Vetcha Satya Lalita Samhita, Hyderabad (IN); Joshita Aratikatla, Hyderabad (IN)

(21) Appl. No.: 19/169,089

(22) Filed: Apr. 3, 2025

(51) Int. Cl. G10L 13/08; G06F 9/451; G07F 19/00; G10L 15/00; G10L 15/26

(52) U.S. Cl. CPC G10L 13/08; G06F 9/454; G07F 19/201; G10L 15/005; G10L 15/26

(57) ABSTRACT

Systems, methods, and apparatus are provided for adaptive ATM vocalization and printing. At an ATM, a first AI engine may generate a digital text from a voice-based or handwritten user input. At a central server, a second AI engine may identify a language from the digital text and generate a vocalization of translated ATM content in the identified language. The second AI engine may generate a translated receipt template in the identified language. The ATM may output the vocalization of the translated ATM content. The first AI engine may adapt the translated receipt with real-time transaction details and generate an image of the translated receipt for printing at the ATM. Federated learning may aggregate local updates to a lightweight language model maintained at client ATMs to update the second AI engine. The aggregated update may also be transmitted to client ATMs to update the local models.

### FIELD OF TECHNOLOGY

Aspects of the disclosure relate to adapting ATM functionality in real time based on a user language.

### BACKGROUND OF THE DISCLOSURE

Automated Teller Machines (ATMs) often operate in a single language, posing a challenge for users who are not fluent. This limitation is especially problematic for visually impaired users who cannot use visual clues to decode an unfamiliar language on the screen and rely on vocalization features.

Conventionally, hardware constraints limit ATMs to printing receipts in a single language or a small set of languages. ATMs typically rely on preloaded font files or centralized cloud systems. Traditional font-based systems store full character sets that may quickly fill the limited ATM memory. Cloud reliance increases bandwidth costs and risks downtime in an area with low connectivity. Even adding a single new language would require hardware upgrades and/or large regular software updates.

It would be desirable to use generative artificial intelligence (AI) to detect a user language and adapt screen vocalization at an ATM in real time. It would further be desirable to adapt the ATM to print receipts in the user language without requiring hardware modification.

It would be desirable to implement architecture that includes a combination of local and central models to adapt an ATM in real time while lowering bandwidth requirements and promoting system efficiency. It would be desirable to implement federated learning to continuously update an AI model based on local interactions with users in a variety of languages at a set of client ATMs. It would be desirable to implement security protocols within the federated learning structure to protect customer privacy while improving responsiveness at the ATM level.

### SUMMARY OF THE DISCLOSURE

Systems, methods, and apparatus are provided for adaptive ATM screen vocalization and printing.

At an ATM, a first artificial intelligence (AI) engine may receive a voice-based input or handwriting-based input from a user. The first AI engine may generate a digital text from the input.

At a central server, a second AI engine may include a generative AI model. The second AI engine may identify a language associated with the digital text. The second AI engine may determine a confidence level associated with an identified language. If the confidence level is above a predetermined threshold, ATM screen content may be translated to the identified language and a vocalization of the translated screen content may be generated. If the confidence level is at or below the predetermined threshold, the second AI engine may proceed with a default language.

At the ATM, the identified language may be confirmed by the user. The ATM may output the vocalization of the translated screen content.

The second AI engine may generate a translated receipt template based on a type of transaction and the identified language and transmit the template to the ATM. In response to receiving a print request at the ATM, the translated receipt template may be modified to include the transaction details. The first AI engine may generate an image of a translated receipt. The ATM may print the image of the translated receipt.

The second AI engine may include a central language identification model. The ATM may maintain a relatively lightweight local version of the language identification model. The ATM may generate a local update to the language identification model based on input from a user at the ATM in the identified language. The ATM may anonymize and encrypt the local update for transmission to a federated learning module at the central server.

The federated learning module may generate an aggregated update based on anonymized local updates received from a set of client ATMs. The federated learning module may update the language identification module at the second AI engine based on the aggregated update. The federated learning module may transmit the aggregated update to each ATM in the set of ATMs.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative process flow in accordance with principles of the disclosure; and

FIG. 4 shows an illustrative process flow in accordance with principles of the disclosure.

### DETAILED DESCRIPTION

Systems, methods, and apparatus are provided for adaptive ATM screen vocalization and printing.

For the sake of illustration, the invention will be described as being performed by a “system.” The system may include one or more features of apparatus and methods that are described herein and/or any other suitable device or approach.

Existing multilingual supports at an ATM are typically limited to a small, fixed set of languages and cannot adapt to diverse user needs.

The system may adapt an ATM in real time for multi-lingual screen vocalization and printing. The system may use both local and central multi-modal AI engines to identify a language, translate and vocalize text, generate receipts, and perform any suitable operations. The multi-modal AI engines may adapt vocalization and printing hardware already present at the ATM.

The system may include one or more ATMs. The ATM may include a display screen. The screen may be touch-enabled. The ATM may include terminal software. The terminal software may include a screen vocalization module and a printer module. The terminal software may control ATM hardware such as a display screen, microphone, speaker, printer, card reader, and/or any suitable hardware.

### ADAPTIVE SCREEN VOCALIZATION

The ATM may receive a user input. The user input may be an ATM access card. The ATM access card may be associated with a user account. The user account may be pre-associated with a user language preference. In some embodiments, the language preference may be encoded on the ATM card. The language preference may be associated with a user identifier encoded on the ATM card. The language preference may have been predetermined in the course of interactions at a previous ATM session, at an enterprise mobile application, at an enterprise web portal, in communications with a customer service agent, during registration with a financial institution, or via any suitable method.

The user input may be a voice-based input. The user input may be a written input. The written input may be a touch-based input received at an ATM screen. The user input may be a greeting, an initial prompt, or any suitable input.

The ATM may include a first AI engine. The first AI engine may include an asynchronous client library. Asynchronous programming may allow tasks to run concurrently, enabling the main thread to continue executing while waiting for other operations to complete. Asynchronous programming may improve system efficiency and responsiveness.

The first AI engine may generate a digital text from the user input. The first AI engine may include a voice-to-text module. The voice-to-text module may operate on a voice-based input. The first AI engine may include optical character recognition algorithms. Optical character recognition may operate on a written input.

The system may include an application programming interface (API). The API may mediate access to a central server. The first AI engine may access the API. The API may transmit the digital text generated at the first AI engine to the central server. In a case where the user language preference was previously identified, the ATM terminal software may access the API. The API may transmit the stored language preference to the central server.

The central server may include a second AI engine. The second AI engine may include a generative AI model. The generative AI model may include a Large Language Model. The API may transmit the digital text generated at the ATM to the second AI engine.

The second AI engine may include a language identification module. The language identification module may determine a user language from the digital text. The language identification module may receive updates and/or new training sets to include new languages or dialects. The language identification module may receive updates from client ATMs using federated learning protocols as described below.

The second AI engine may include a confidence calculation module. The confidence calculation module may assess the accuracy of the determination by the language identifier. The confidence calculation module may be pretrained on data sets to measure accuracy, recall, precision, or any suitable metric associated with the output of the language identification module. The confidence calculation module may output a score, a percentage or any suitable measure of confidence level. This protocol may protect the system in the event the user enters nonsense that is not associated with any language at the ATM. In the event that the output of the confidence calculation is below a predetermined threshold, a default language may be selected.

The second AI engine may include a language translation module. The language translation module may translate ATM screen content. The screen content may include user prompts, transaction instructions, transaction confirmation, product information, and/or any suitable content.

The second AI engine may include a voice modulation module. The voice modulation module may adjust the translation based on colloquial usage, dialect, and/or any other suitable factors.

The second AI engine may include a text-to-speech module. The text-to-speech module may convert the translation to a voice-based output. The API may interface with the ATM. The ATM terminal software may use vocalization hardware to present the voice-based output to the user.

### ADAPTIVE RECEIPT PRINTING

The second AI engine at the central server may include a dynamic receipt template module. The dynamic receipt template module may generate a receipt template based on the type of transaction selected by the user at the ATM. The receipt template may be based on the language identification at the second AI model.

The ATM may include a dynamic receipt building module. The API may transmit the receipt template from the central server to the ATM. In response to user input of a print request at the ATM, the ATM may provide transaction details to the receipt building module. The receipt building module may generate a receipt for the transaction using the template and the transaction details. The template may be modified locally instead of at the central server to protect user transaction data.

The first AI engine may include a text-to-image module. The text-to-image module may generate an image of the receipt. Conversion to an image enables the ATM to print in any language without reprogramming the ATM hardware. The image of the receipt may be transmitted to an ATM printer module. The printer module may print the receipt image using ATM printer hardware.

### FEDERATED LEARNING PROTOCOLS

The second AI engine at the central server may include a global model for language identification and translation. The system may maintain a local copy of the language identification model at an ATM. Input from a user at the ATM may be applied to train and update the local copy of the language model.

The local language model may be a lightweight model. A lightweight AI model may be optimized to be more efficient and use fewer resources. In some cases, a larger and more complex model may be distilled into a smaller and faster version. In some cases, a lightweight model may be used for local processing at edge devices.

The system may include a federated learning module. The federated learning module may be associated with a central server. Federated learning is a collaborative machine learning protocol in which multiple devices operate to train a central model without sharing their private datasets.

The federated learning module may be in communication with a set of client ATMs. The federated learning module may receive an update to the local language model from one or more of the ATMs.

An update to the local language model may be anonymized at the ATM to protect data privacy. The anonymization may include adding calibrated noise to the model updates to mask individual user contributions. The anonymized update may be encrypted at the ATM prior to transmission.

A federated learning module may aggregate the anonymized updates received from the ATMs. The federated learning module may use Secure Aggregation for Federated Learning (SAFL), Federated Byzantine Aggregation (FBA), or any suitable aggregation protocol.

The aggregation protocol may encode the data cryptographically to prevent tampering. The aggregation may be weighted based on any suitable metric. For example, the aggregation may be weighted based on the number or volume of interactions at the ATM in a particular language.

The aggregated update may be applied to improve the global language model. The central server may continuously or periodically push the update to the ATMs. An ATM may incorporate the update into the local language model. In some embodiments, the central server may push an updated version of the global language model to the ATMs.

In some embodiments, the updates may be selective and not continuous in order to balance model training with conservation of computing resources. In this case, an update to the global model may be transmitted to the ATMs only when it meets a threshold level of significance. The threshold may be based on a minimum accuracy improvement, a specific number of new user interactions, or any suitable metric.

In some embodiments, instead of an ATM, the architecture may include a mobile device application at a user mobile device. The mobile device application may receive an input from a user. The mobile device application may include a first AI engine. The first AI engine may generate a digital text from the user input.

The digital text may be transmitted to the central server using an API gateway. The second AI engine may identify a user language and translate mobile device application content. The content may include interactions with an interactive response system such as a chatbot. The content may include interactions with a live agent. The second AI engine may generate a vocalization of the translated content. The second AI engine may generate a template for a document associated with the mobile device application content in the identified user language.

Federated learning protocols may also be applied in this embodiment. The mobile device application may maintain a lightweight local version of a language identification model and may learn from user input. Anonymized updates to the local model may be aggregated at the central server and applied to update the language identification model at the second AI engine. The aggregated update may be pushed to a mobile device application to update the local model. The mobile device application may store a user language preference for future interactions.

In some embodiments, instead of an ATM, the architecture may include another type of self-service kiosk.

One or more non-transitory computer-readable media storing computer-executable instructions are provided. When executed by a processor on a computer system, the instructions may perform a method for adaptive ATM vocalization and printing.

The method may include receiving a user input at an ATM. The input may be a voice-based input, a handwritten input, and/or any other suitable input. The method may include, at a first AI engine, generating a digital text from the user input.

The method may include, at a central server, at a second AI engine, identifying a language associated with the digital text and determining a confidence level associated with an identified language.

The method may include, if the confidence level is above a predetermined threshold, translating ATM screen content to the identified language and generating a vocalization of the translated ATM screen content. The method may include, in response to a user input confirming the identified language, vocalizing the translated ATM content.

The method may include at the second AI engine, generating a translated receipt template in the identified language for a type of transaction. The method may include, in response to a print request at the ATM, at the first AI engine, modifying the translated receipt template with real-time transaction details. The method may include generating an image of a translated receipt and printing the image of the translated receipt at an ATM printer.

The method may include using federated learning protocols to aggregate local updates to a language identification model received from client ATMs. The local updates may be anonymized to mask user data and weighted based on the amount of interaction in each language. The method may include applying the aggregated update to a central language identification model at the second AI engine. The method may include transmitting the aggregated update to the local language identification models maintained at the client ATMs.

In some embodiments, the method may include selectively transmitting the aggregated update to the client ATMs only when the update exceeds a threshold significance.

The method may include identifying a stored language preference for a user at the ATM and transmitting the stored language preference to the second AI model at the central server.

The method may include, if the confidence level is below a predetermined threshold, generating a vocalization of ATM content in a default language.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

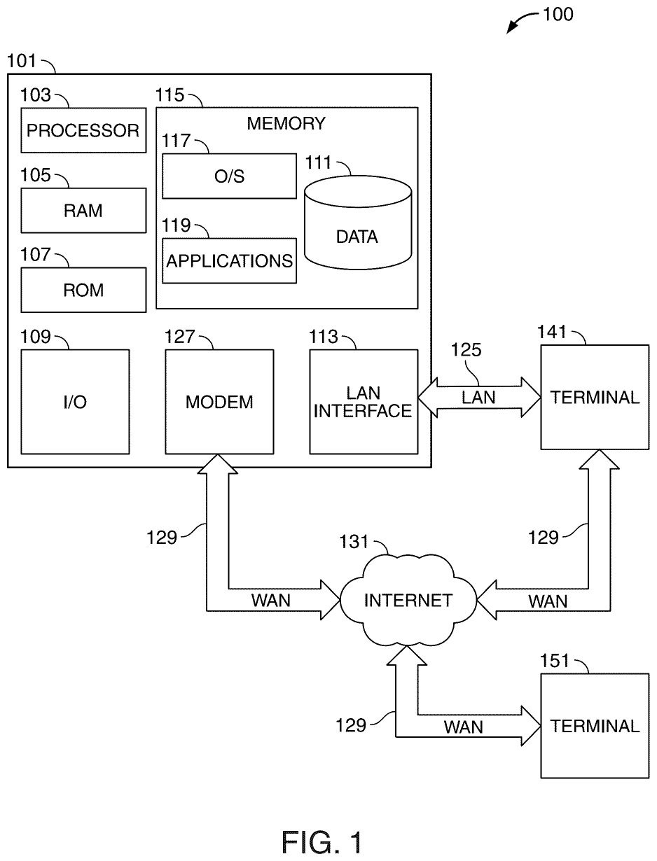

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

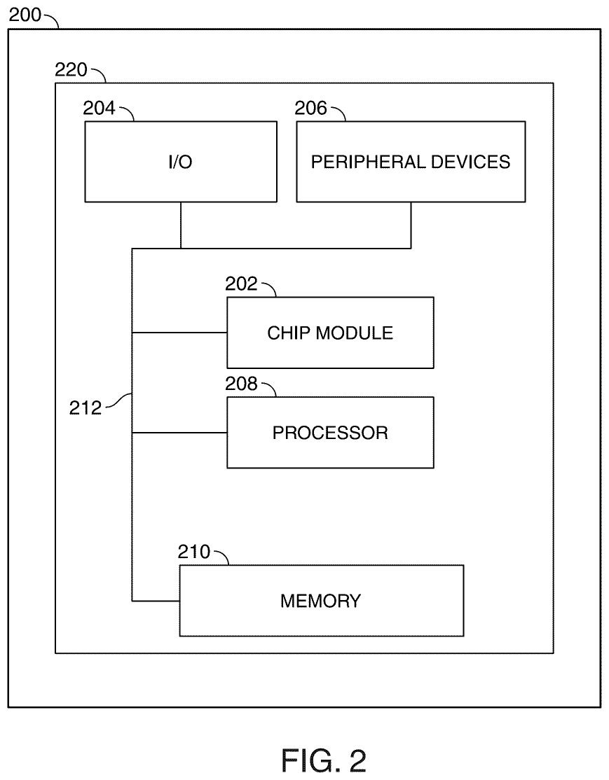

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

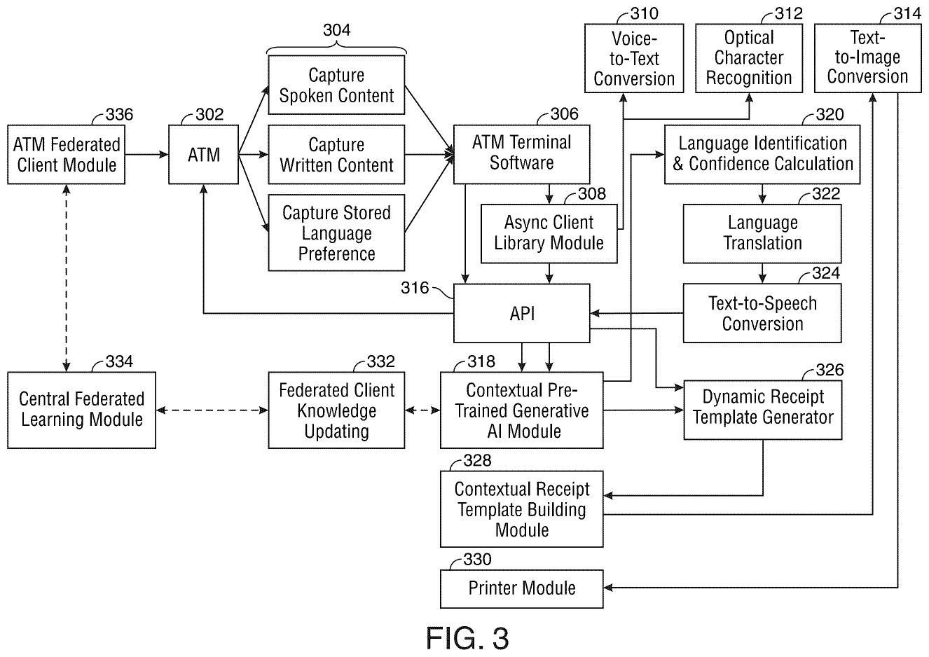

FIG. 3 shows illustrative process flow 300 for adapting ATM capabilities. At 302, a user may interact with an ATM. At 304, the ATM may receive an input from a user. The ATM may capture a stored language preference for the user. The ATM may capture a handwritten input from the user. The ATM may capture a voice-based input from the user.

At 306, the ATM terminal software may process the inputs. At 308, an asynchronous client library module may use AI to generate a digital text from a handwritten input or voice-based input. At 310, a voice-to-text converter may convert a voice-based input to a digital text. At 312, optical character recognition may convert a handwritten input to a digital text.

At 316, a stored language preference may be transmitted from the terminal software through an API gateway. A digital text may be transmitted from the asynchronous client library module through the API gateway. The API may transmit the stored language or the digital text to a central server.

At 318, a contextual pretrained generative AI module may receive the digital text and generate a vocalization in a user language. At 320, language identification may identify a user language and calculate a confidence level for the identification. At 322, if a confidence level for the language identification meets a predetermined threshold, the ATM content may be translated to the identified language. At 324, a text-to-speech engine may convert the translated ATM content to a vocalization. The vocalization may be transmitted to the terminal software at 306 through the API at 316.

At 326, a receipt template may be dynamically generated in the identified language. At 328, in response to input of a print request at ATM 302, a contextual receipt template building module may adapt the receipt based on transaction details from the ATM session. At 314, an AI-based text-to-image converter may generate an image from the translated receipt. At 330, an ATM printer module may print the receipt image.

At 336, an ATM federated client module may generate an update for a local language identification model maintained at the ATM. The update may be based on interactions with a user in a language not supported at ATM software and hardware. At 334, a central federated learning module may receive anonymized updates from client ATMs. In some embodiments, updates may be received and then anonymized by the federated learning module. The central federated learning module may aggregate the updates.

At 332, the aggregated update may be applied to the contextual pre-trained generative AI model. The aggregated update may also be transmitted from the central federated learning module back to the ATM federated client module to apply to the local language identification model.

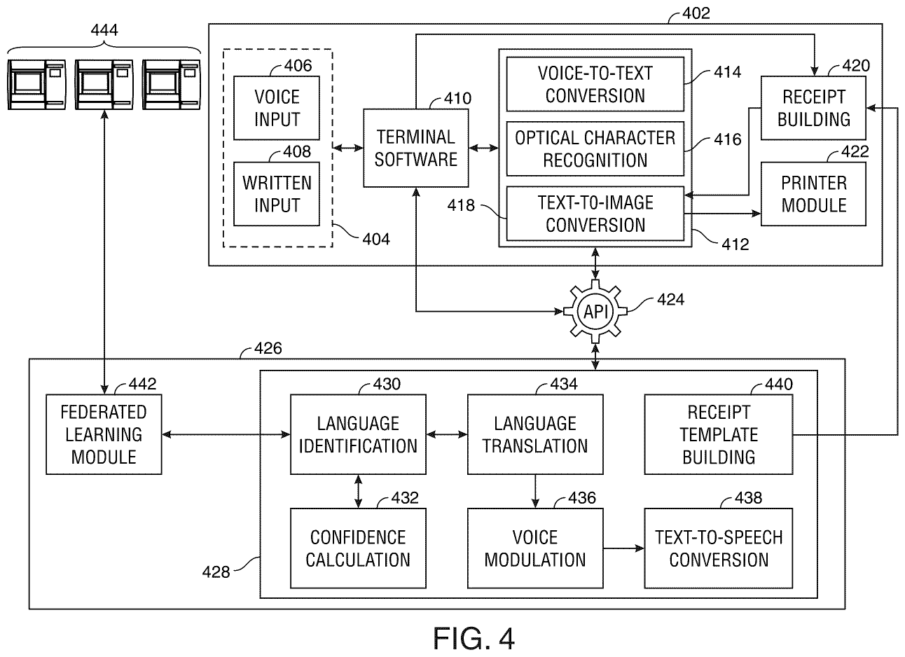

FIG. 4 shows illustrative architecture 400 for adapting ATM capabilities. ATM 402 may be part of a set of ATMs 444. ATM 402 may receive user input 404. User input 404 may include voice-based input 406 and/or written input 408.

Terminal software 410 may capture user input 404. First AI engine 412 may convert user input 404 into a digital text. Voice-to-text conversion 414 may convert voice input 406 into a digital text. Optical character recognition 416 may convert written input 408 into a digital text.

API gateway 424 may transmit the digital text to central server 426. In a case where a user has a stored language preference, terminal software 410 may retrieve the stored language preference. API gateway 424 may transmit the stored language preference to central server 426.

Central server 426 may include second AI engine 428. Second AI engine 428 may include generative AI models that perform a range of functions. Language identification module 430 may identify a language from the digital text. Confidence calculation module 432 may output a confidence level for the language identification. If the confidence level is below a predetermined threshold, the second AI engine may generate a vocalization in a default language. The default language may be predetermined based on the geographic location of an ATM and/or on any suitable factor.

Language translation module 434 may translate ATM screen content to the identified language. Voice modulation module 436 may adjust the translation for vocalization. Text-to-speech conversion module 438 may generate a vocalization for the ATM content in the identified language. Second AI engine 426 may transmit the vocalization to terminal software 410 via API gateway 424.

Second AI engine 426 may include receipt template building module 440. Receipt template building module may generate a receipt template in the identified language. The receipt template may be associated with a type of transaction. The receipt template may be based on user selections at ATM 402 that are received from terminal software 410 via API gateway 424.

Receipt template building module 440 at central server 426 may transmit the generated receipt template to receipt building module 420 at ATM 402. In some embodiments, the receipt template may be transmitted via API gateway 424. Receipt building module 420 may receive transaction details from terminal software 410. Receipt building module 420 may generate a receipt in the identified language by modifying the template to include the transaction details. The receipt may be generated locally at ATM 402 to avoid exposing the transaction details during transmission to the central server.

First AI engine 412 may include text-to-image module 418. Text-to-image module 418 may convert the receipt into an image. The receipt may be transmitted to printer module 422 to print on ATM hardware.

ATMs 444 (including ATM 402) may each maintain a lightweight local version of language identification model 430. The local models may be updated based on interactions with users in their preferred languages. ATMs 444 may anonymize the local updates to mask data that could identify a user. ATMs 444 may encrypt the updates for transmission to central server 426. In some embodiments, the update may be transmitted via API gateway 424.

Federated learning module 442 may receive the anonymized updates. Federated learning module 442 may aggregate the updates while continuing to hide data that identifies a user. Federated learning module 442 may weight the aggregation protocols based on the number or volume of interactions at an ATM in a particular language. Federated learning module 442 may generate a federated knowledge update.

Federated learning module 442 may update language identification module 430 with the federated knowledge update. Federated learning module 442 may transmit the federated knowledge update to ATMs 444. In some embodiments, federated learning module 442 may transmit the federated knowledge update only when a threshold significance has been met. In some embodiments, federated learning module 442 may transmit an updated version of the model to ATMs 444.

Thus, methods and apparatus for ADAPTIVE CONTEXT-BASED ATM SCREEN VOCALIZATION AND PRINTING are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for adaptive automated teller machine (ATM) vocalization and printing, the method comprising:
at an ATM, at a first artificial intelligence (AI) engine:
receiving a user input comprising a voice-based input; and
generating a digital text from the user input;
at a central server, at a second AI engine comprising a generative AI model:
identifying a language associated with the digital text generated at the ATM;
determining a confidence level associated with an identified language;
in response to determination of a confidence level above a predetermined threshold, translating ATM screen content and generating a vocalization of the translated ATM screen content in the identified language; and
generating a translated receipt template based at least in part on a type of transaction and the identified language;
at the ATM:
receiving the vocalization of the translated ATM content from the second AI model;
in response to receiving confirmation of the identified language from the user, vocalizing the translated ATM content;
in response to an ATM input comprising a print request, modifying the translated receipt template based on transaction details;
generating an image of a translated receipt; and printing the image of the translated receipt at an ATM printer.

2. The method of claim 1, further comprising federated learning based on interactions at the ATM, wherein the second AI model comprises a central version of a Large Language Model (LLM):
maintaining a local client version of the LLM at the ATM;
generating a local update to the local client version of the LLM based on input from the user at the ATM in the identified language;
anonymizing and encrypting the local update for transmission to a federated learning algorithm;
at the federated learning algorithm, generating an aggregated update based on anonymized local updates received from a set of ATMs;
updating the central version of the LLM based on the aggregated update; and
at each ATM in the set of ATMs, updating a local client version of the LLM based on the aggregated update.

3. The method of claim 2, the anonymizing comprising masking ATM user data by adding calibrated noise to the local update.

4. The method of claim 2, the aggregating comprising modifying a weight in the federated learning algorithm based on a volume of interactions in a language at an ATM.

5. The method of claim 2, further comprising, selectively transmitting an aggregated update to the set of ATMs only when the update exceeds a threshold significance.

6. The method of claim 1, further comprising, at the ATM, identifying a stored language preference for a user and transmitting the stored language preference to the second AI model at the central server.

7. The method of claim 1, further comprising, in response to determination of a confidence level below a predetermined threshold, generating a vocalization of ATM content in a default language.

8. One or more non-transitory computer-readable media storing computer-executable instructions which, when executed by a processor on a computer system, perform a method for adaptive automated teller machine (ATM) vocalization and printing, the method comprising:
receiving a user input at an ATM comprising a voice-based input; and
generating a digital text from the user input;
identifying a language associated with the digital text;
determining a confidence level associated with an identified language;
in response to determination of a confidence level above a predetermined threshold, translating ATM screen content and generating a vocalization of the translated ATM screen content in the identified language; and
in response to a user input confirming the identified language, vocalizing the translated ATM content;
generating a translated receipt template based at least in part on a type of transaction and the identified language;
in response to a user input comprising a print request, modifying the translated receipt template based on transaction details;
generating an image of a translated receipt; and
printing the image of the translated receipt at an ATM printer.

9. The media of claim 8, further comprising federated learning based on interactions at the ATM, wherein a language is identified at a central version of a Large Language Model (LLM), the method further comprising:
maintaining a local client version of the LLM at the ATM;
generating a local update to the local client version of the LLM based on input from the user at the ATM in the identified language;
anonymizing and encrypting the local update for transmission to a federated learning algorithm;
at the federated learning algorithm, generating an aggregated update based on anonymized local updates received from a set of ATMs;
updating the central version of the LLM based on the aggregated update; and
at each ATM in the set of ATMs, updating a local client version of the LLM based on the aggregated update.

10. The media of claim 9, the anonymizing comprising masking ATM user data by adding calibrated noise to the local update.

11. The media of claim 9, the aggregating comprising modifying a weight in the federated learning algorithm based on a volume of interactions in a language at an ATM.

12. The media of claim 9, further comprising, selectively transmitting an aggregated update to the set of ATMs only when the update exceeds a threshold significance.

13. The media of claim 8, further comprising, at the ATM, identifying a stored language preference for a user and transmitting the stored language preference to a generative AI model at a central server.

14. The media of claim 8, further comprising, in response to determination of a confidence level below a predetermined threshold, generating a vocalization of ATM content in a default language.

15. A system for adaptive automated teller machine (ATM) vocalization and printing, the system comprising:
an ATM comprising a first artificial intelligence (AI) engine and configured to:
receive a user input comprising a voice-based input; and
generate a digital text from the user input;
a central server comprising at a second AI engine configured to:
identify a language associated with the digital text generated at the ATM;
determine a confidence level associated with an identified language;
in response to determination of a confidence level above a predetermined threshold, translate ATM screen content and generate a vocalization of the translated ATM screen content in the identified language; and
generate a translated receipt template based at least in part on a type of transaction and the identified language;
the ATM further configured to:
receive the vocalization of the translated ATM content from the second AI model;
in response to receiving confirmation of the identified language from the user, vocalizing the translated ATM content;
in response to an ATM input comprising a print request, modify the translated receipt template based on transaction details;
generate an image of a translated receipt; and
print the image of the translated receipt at an ATM printer.

16. The system of claim 15, the central server further comprising a federated learning protocol based on interactions at the ATM, wherein the second AI model comprises a central version of a Large Language Model (LLM), the federated learning protocol comprising:
maintaining a local client version of the LLM at the ATM;
generating a local update to the local client version of the LLM based on input from the user at the ATM in the identified language;
anonymizing and encrypting the local update for transmission to a federated learning algorithm;
at the federated learning algorithm, generating an aggregated update based on anonymized local updates received from a set of ATMs;
updating the central version of the LLM based on the aggregated update; and
at each ATM in the set of ATMs, updating a local client version of the LLM based on the aggregated update.

17. The system of claim 16, the anonymizing comprising masking ATM user data by adding calibrated noise to the local update.

18. The system of claim 17, the aggregating comprising modifying a weight in the federated learning algorithm based on a volume of interactions in a language at an ATM.

19. The system of claim 17, the federated learning protocol further comprising selectively transmitting an aggregated update to the set of ATMs only when the update exceeds a threshold significance.

20. The system of claim 16, the ATM further configured to identify a stored language preference for a user and transmit the stored language preference to the second AI model at the central server.

21. The system of claim 16, the central server further configured to, in response to determination of a confidence level below a predetermined threshold, generate a vocalization of ATM content in a default language.
